(19) United States
(12) Patent Application Publication
(10) Pub. No.: US 2007/0115770 A1
(43) Pub. Date: May 24, 2007

(54) Optical pickup apparatus

(75) Inventor: Shinya Shimizu, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/602,973

(22) Filed: Nov. 22, 2006

(30) Foreign Application Priority Data
Nov. 24, 2005 (JP) 2005-338103

(51) Int. Cl. G11B 19/00

(52) U.S. Cl. 369/47.5

(57) ABSTRACT

An optical pickup apparatus has a photodetector and a current-voltage conversion circuit to detect a laser beam emitted from a laser diode, and output a light detection signal which varies in voltage according to the laser beam power. An offset voltage controller sets an offset voltage which is a difference voltage between a light detection signal voltage corresponding to a recording power of the laser beam and that corresponding to an erasing power thereof. An offset operator subtracts the offset voltage from the light detection signal voltage to offset the light detection signal while the laser beam is emitted to record a mark on an optical disc. The offset light detection signal containing errors is amplified and output to a laser emission controller. Thus, the laser emission controller controls using the amplified light detection signal with amplified errors, thereby controlling, with high accuracy, the laser beam power even if high.

### BACKGROUND OF THE INVENTION

1. Field of the Invention

The present invention relates to an optical pickup apparatus capable of controlling the power of a laser beam to be irradiated onto an optical recording medium.

2. Description of the Related Art

Among optical discs as optical recording media, CDs (Compact Discs) capable of recording/reading data have become widespread in recent years. Further, DVDs (Digital Versatile Discs) having a larger capacity than CDs are used by many users. In a CD or a DVD, a laser beam is irradiated onto an optical disc to record data so as to form or record a record mark on the optical disc. For example, in a rewritable DVD, data is recorded in a data recording layer based on phase-change technology The data recording layer is formed of a phase-change material which reversibly changes between a crystalline phase (crystalline state) and an amorphous phase (non-crystalline state).

For recording data using a phase-change optical disc, a laser beam having a high power is irradiated and condensed on an area of the data recording layer. The area of the data recording layer, on which the laser beam is condensed, is thereby heated to a high temperature to cause irregular atomic structure. Thereafter, the laser beam condensed area of the data recording layer is quenched and solidified with the atomic structure being kept irregular, so as to be converted into a non-crystalline state, namely turned amorphous. The area of the data recording layer having thus been turned amorphous serves as a record mark.

On the other hand, for erasing data, a laser beam having a power of about one-tenth of that for recording data is irradiated and condensed on the data recording layer, whereby the laser beam heats the data recording layer to a temperature required for crystallization. This causes the amorphous area of the data recording layer (record mark) to turn crystalline, thereby erasing the record mark, and maintains the other already crystalline area, so that the entire data recording layer becomes crystalline. Here, the erasure of the record mark can also be referred to as recording of a space, which converts the area of the record mark back to an area with no record mark.

Note that for reading data, a laser beam having a power which is still lower than that for erasing data is irradiated onto the data recording layer. The data recording layer in the crystalline area has a different reflectance from that in the amorphous area (record mark), so that the amount of laser beam reflected from the crystalline-area is different from that reflected from the amorphous area. Thus, it is possible to read data by detecting presence or absence of a record mark based on a difference of amount of the reflected laser beam.

There is a trend of increasing recording capacity. In order to adapt to the trend, a DVD having two recording layers has been put to practical use. Such DVD has an advantage of twice the recording capacity over a DVD having a single recording layer. However, there is a need for more accurate power control. More specifically, it is required to provide a laser beam having a high power in order to irradiate a laser beam onto a second data recording layer, which is positioned deeper than a first data recording layer close to the surface of the DVD, so as to form a record mark. In addition, there is a trend of higher recording speed. This causes an increase in the speed of recording data on an optical disc as well as a reduction in the time of irradiating the laser beam for forming or recording a record mark. Thus, it is required to increase the power of a laser beam for irradiation, and to securely change the crystalline state while the laser beam is irradiated onto each data recording layer. Accordingly, it is required that the power of a laser beam for irradiation to an optical disc be controlled with high accuracy, particularly for irradiation with high power.

An optical pickup apparatus with laser control is known which has a photodetector for receiving a laser beam emitted from a laser diode and for generating a control signal varying in amplitude according to the power of the laser beam, and which also has a control circuit for controlling the laser diode based on the control signal. When the irradiated laser beam has a high power in such optical pickup apparatus, the amplitude of the control signal is reduced for input to the control circuit. This is done so that the amplitude of the control signal, which increases as the power of the laser beam increases, falls within the dynamic range of the control circuit. This enables the power control of even a laser beam having a high power.

Further, a laser control apparatus for peak power control is known which has a photodetector for receiving light pulses emitted from a semiconductor laser. Based on the average power value and duty of the received light pulses, a peak power value of the light pulses is obtained by calculation so as to obtain, by calculation, a difference between the thus obtained peak power value and a target peak power value. When an actual duty of the light pulses emitted from the semiconductor laser is different from a target duty, the laser control apparatus corrects the calculation with reference to the difference so as to control the semiconductor laser with high accuracy, based on the corrected calculation results (refer to e.g. Japanese Laid-open Patent Publication 2005-166237).

An optical pickup apparatus for controlling the output intensity level of a laser beam to be irradiated onto an optical recording medium is known, in which the laser beam is switched between a multi-pulse beam and a single pulse beam based on data to be recorded on the optical recording medium such that the single pulse beam is emitted when recording data on the optical recording medium in a predetermined time. In this optical pickup apparatus, a laser beam is detected, and the light intensity level of the detected laser beam is obtained as a sample value in the predetermined time. Subsequently, an error between the obtained sample value and a target sample value is obtained by calculation, so as-to control the output intensity level of the laser beam based on the thus obtained error.

In this optical pickup apparatus, the laser beam is normally emitted in the form of multi-pulse beam. The laser beam is switched from the multi-pulse beam to the single pulse beam only when recording a space(s) while the control of the output intensity level is performed. For recording data, the intensity level of the laser beam is switched between an intensity level to record a mark and an intensity level to record a space on an optical disc (refer to e.g. Japanese Laid-open Patent Publication 2004-220663).

An optical disc apparatus for laser power control is known which has: a photodiode for emitting a laser beam; a photodetector for detecting the intensity of the laser beam emitted from the laser diode; a current-voltage conversion circuit for generating, based on the detected intensity, a laser power signal representing the laser power; and a laser power control unit for generating a laser power control signal based on the laser power signal to change the laser power of the laser beam. This optical disc apparatus is designed so that the control characteristics of the laser power control unit is changed to increase the response speed of the laser power control unit during a predetermined time from the time the laser power of the laser beam is changed (refer to e.g. Japanese Laid-open Patent Publication 2003-317295).

In addition, an optical information recording apparatus for optimizing the power of a laser beam while recording data on an optical disc is known which generates a recording pulse signal to modulate the light intensity of a laser beam source according to information to be recorded on a recording medium, and which has a laser driver for driving the laser beam source to emit a laser beam as well as a laser beam detection unit for detecting the emitted laser beam. This optical information recording apparatus comprises a sampling unit for sampling the detection output signal of a photodiode and a sampling timing generation unit for generating a sampling timing to instruct sampling to the sampling unit, in which the sampling timing generation unit generates a sampling timing delayed for at least a response time of a propagation path including the laser driver, laser beam source and laser beam detection unit (refer to e.g. Japanese Laid-open Patent Publication 2001-357529).

However, these known apparatus have problems. The first described optical pickup apparatus suffers from a problem that the detection sensitivity decreases to reduce the accuracy of the laser beam power control, because the amplitude of a control signal is reduced for input to the control circuit. In the laser control apparatus described in Japanese Laid-open Patent Publication 2005-166237, it is possible to control the laser power with high accuracy even when a duty error occurs. However, it is not possible to control the laser power with high accuracy when a peak power error occurs.

The optical pickup apparatus described in Japanese Laid-open Patent Publication 2004-220663 uses a single pulse beam emitted in a predetermined time, such as when recording a space on an optical disc, so as to make it possible to independently control a laser beam having an intensity level for recording a space among laser beams having different intensity levels. However, this optical pickup apparatus operates without reference to the dynamic range of a control circuit. Thus, when a laser beam with a very high intensity is emitted e.g. due to a control error, such apparatus cannot control the laser beam with high accuracy.

In the optical disc apparatus described in Japanese Laid-open Patent Publication 2003-317295, it is possible to change the power of a laser beam stably at a high speed to control the laser beam. However, when a laser beam having a high power is emitted, it is not possible to detect a small power error caused by a control error so as to increase the detection sensitivity to control the power of the laser beam with high accuracy.

In the optical information recording apparatus described in Japanese Laid-open Patent Publication 2001-357529, the sampling timing for detecting a reflected laser beam is made variable according to the propagation delay time of the propagation path, whereby it is possible to continuously maintain an optimum sampling timing for sampling a detection output signal without being influenced by variable factors such as variations in circuit performance. This makes it possible to achieve optimum control of the laser beam power while recording data on a recording medium such as an optical disc. However, when a laser beam having a high power is emitted, it is not possible to detect a small power error with high sensitivity to control the high power laser beam with high accuracy.

### SUMMARY OF THE INVENTION

An object of the present invention is to provide an optical pickup apparatus capable of controlling the power of a laser beam with high accuracy even when emitting a laser beam having a high power.

This object is achieved according to the present invention by an optical pickup apparatus comprising: a light emitting unit for emitting a laser beam to an optical recording medium; a light control unit for controlling power of the laser beam emitted from the light emitting unit; a light detection unit for receiving and detecting the laser beam emitted from the light emitting unit, and outputting a light detection signal which varies in voltage according to the-power of the detected laser beam; an offset unit for subtracting an offset voltage from the voltage of the output light detection signal so as to offset the light detection signal; and an amplifier unit for amplifying the offset light detection signal, and outputting the amplified light detection signal to the light control unit. Based on the amplified light detection signal, the light control unit controls the power of the laser beam emitted from the light emitting unit.

According to the present invention, the light detection unit receives and detects a laser beam emitted from the light emitting unit, and outputs a light detection signal which varies in voltage according to the power of the laser beam. The light detection signal output from the light detection unit is offset by the offset unit so as to reduce its voltage by an offset voltage. The light detection signal having thus been offset is amplified by an amplifier unit, and output to the light control unit. Based on the thus amplified light detection signal which contains amplified errors, the light control unit controls the power of the laser beam emitted from the light emitting unit. In this optical pickup apparatus, a small change in the voltage of a light detection signal, which is caused by a small change in the power of a laser beam, causes an amplified change in the voltage of the amplified light detection signal with amplified errors. This makes it possible to control the laser beam power with high accuracy based on the amplified light detection signal with the amplified errors. In addition, since the light detection signal is amplified after offset, it is possible to allow the voltage of the light detection signal, input to the light control unit subsequent to the amplification, to fall within the dynamic range of the light control unit, making it possible to control the power of the laser beam with high accuracy.

Preferably, the optical pickup apparatus further comprises an offset control unit for controlling the offset voltage. Based on a signal from the light control unit, the light emitting unit emits a laser beam having a recording power to record a mark on the optical recording medium, and also emits a laser beam having an erasing power to erase the mark recorded on the optical recording medium, thereby recording information on the optical recording medium. The offset control unit sets an offset voltage which is a difference voltage between the voltage of a light detection signal corresponding to the recording power of the laser beam and that corresponding to the erasing power of the laser beam. Further, the offset unit subtracts the offset voltage from the voltage of the light detection signal while the laser beam is emitted to the optical recording medium to record the mark thereon.

In the optical pickup apparatus according to the preferred mode, the light detection unit receives and detects a laser beam emitted from the light emitting unit, and outputs a light detection signal which varies in voltage according to the power of the laser beam. The light detection signal output from the light detection unit is offset by the offset unit so as to reduce its voltage by an offset voltage. The light detection signal having thus been offset is amplified by an amplifier unit, and output to the light control unit. Based on the thus amplified light detection signal which contains amplified errors, the light control unit controls the power of the laser beam emitted from the light emitting unit.

According to the optical pickup apparatus having such structure, the light detection signal is amplified after offset, so that it is possible to control the voltage of the light detection signal, input to the light control unit subsequent to the amplification, not to exceed the dynamic range of the light control unit, making it possible to control the power of the laser beam with high accuracy. Furthermore, a small change in the voltage of a light detection signal, which is caused by a small change in the power of a laser beam, causes an amplified change in the voltage of the amplified light detection signal with amplified errors. This makes it possible to control the laser beam power with high accuracy based on the amplified light detection signal with-the amplified errors.

In addition, based on a signal from the light control unit, the light emitting unit emits a laser beam having a recording power to record a mark on the optical recording medium, and also emits a laser beam having an erasing power to erase the mark recorded on the optical recording medium, thereby recording information on the optical recording medium. The offset control unit sets an offset voltage which is a difference voltage between the voltage of a light detection signal corresponding to the recording power of the laser beam and that corresponding to the erasing power of the laser beam. Further, the offset unit subtracts the offset voltage from the voltage of the light detection signal while the laser beam is emitted to the optical recording medium to record the mark. The offset light detection signal is amplified by the amplifier unit and input to the light control unit. Based on the amplified light detection signal, the light control unit controls the power of the laser beam emitted from the light emitting unit.

In the optical pickup apparatus having such structure, a voltage of the light detection signal corresponding to the recording power is reduced to that corresponding to the erasing power. Even if the recording power is high, namely even if the light detection signal voltage for mark recording is high, the light detection signal voltage is offset by a difference voltage between the light detection signal voltage based on the high recording power and that based on the erasing power. This makes it possible to amplify the light detection signal, within a range not exceeding the dynamic range of the light control unit, more than without offsetting the light detection signal input to the light control unit. For example, a small change in the voltage of a light detection signal, which is caused by a small change in the power of a laser beam, causes an amplified change in the voltage of the amplified light detection signal with amplified errors. Accordingly, the light control unit can detect a small change in the power of the laser beam. This makes it possible to control the power of the laser beam with high accuracy even if the power of the laser beam emitted for mark recording is high.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram of an optical pickup apparatus according to an embodiment of the present invention;

FIG. 2 is a schematic block diagram of a laser power control unit of the optical pickup apparatus;

FIGS. 3A to 3E are a set of graphs showing various signals in the laser power control unit of FIG. 2 when recording data on an optical disc, in which FIG. 3A is a graph showing the power of a laser beam at point A, while FIG. 3B to FIG. 3E are graphs showing voltages of a mark/space ID (identification) signal at point B, an offset signal at point C, a light detection signal at point D, and a front monitor signal at point E in FIG. 2, respectively; and

FIG. 4 is a graph showing how characteristics of light detection signal voltage versus laser beam power are changed by amplification of the light detection signal.

### DESCRIPTION OF THE PREFERRED EMBODIMENTS

Embodiments of the present invention, as the best mode for carrying out the invention, will be described hereinafter with reference to the annexed drawings. Note that like parts are designated by like reference numerals or reference characters throughout the drawings. It is to be understood that the embodiments described herein are not intended as limiting, or encompassing the entire scope of, the invention. The following description exemplifies a case where the present invention is applied to an optical pickup apparatus to be used for an optical recording medium. Examples of the optical recording media to be applied to the embodiments of the present invention include optical discs such as CD-RW (Compact Disc-Rewritable), DVD−RW (Digital Versatile Disc-Rewritable), DVD+RW (Digital Versatile Disc-Rewritable slightly different from DVD−RW), HD DVD (High Definition DVD) and Blu-ray Disc.

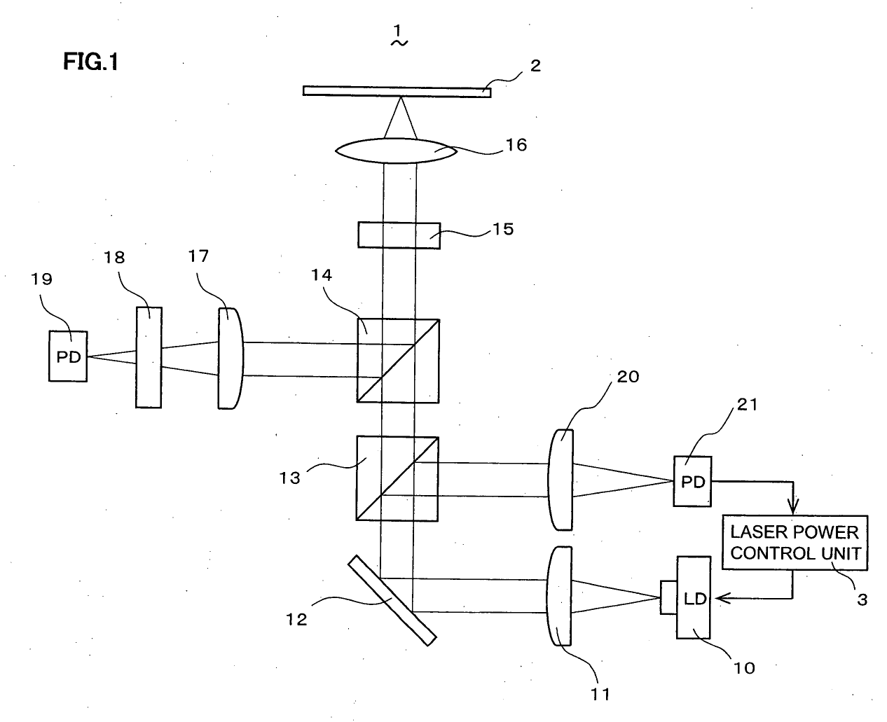

FIG. 1 is a schematic block diagram of an optical pickup apparatus 1 according to an embodiment of the present invention, which is to be mounted e.g. in an optical recording apparatus (not shown). Referring to the optical pickup apparatus 1 of FIG. 1, a semiconductor laser diode unit (hereafter referred to simply as LD unit) 10 emits a laser beam to an optical disc 2. The laser beam is reflected by a beam splitter 13, and enters a photodetector 21 (hereafter, referred to simply as PD) 21. The PD 21 outputs a light detection signal to a laser power control unit 3 based on the laser beam which it receives. Based on the light detection signal, the laser power control unit 3 controls the power of the laser beam emitted from the LD unit 10. The structure of the optical pickup apparatus 1 will be described in detail below.

The LD unit 10 has an infrared emitting LD (laser diode), a red emitting LD and a blue emitting LD. When the optical disc 2 is inserted in the optical disc recording apparatus (not shown), the optical disc recording apparatus determines the type of the optical disc 2, whether CD, DVD, HD DVD or Blu-ray Disc. Based on an output signal from the optical disc recording apparatus, one of the LDs emits a laser beam. If the optical disc 2 is HD DVD or Blu-ray Disc, the blue emitting LD emits a blue laser beam to the optical disc 2. If the optical disc 2 is DVD, the red emitting LD emits a red laser beam, while if the optical disc 2 is CD, the infrared emitting LD emits an infrared laser beam to the optical disc 2. The LD unit 10 thus operates to serve as a light emitting unit. When the optical pickup apparatus 1 is used to record or write data (information) onto the optical disc 2, the LD unit 10 emits a laser beam with a power to record a mark (record mark) on the optical disc 2 while it emits a laser beam with a power to erase or delete the record mark (namely to record a space on an area of the optical disc having the record mark) when erasing or deleting the record mark or recording the space.

The laser beam emitted from the LD unit 10 is incident on and enters a collimating lens 11. The collimating lens 11 converts the entering laser beam into parallel light which is then reflected by a mirror 12 and is directed to the optical disc 2. The laser beam reflected by the mirror 12 enters a beam splitter 13, which splits the laser beam into two laser beams. One of the two laser beams passes or transmits through the beam splitter 13, and is guided onto the optical disc 2 via a polarization beam splitter 14. On the other hand, the other one of the laser beams is reflected by the beam splitter 13, and is guided onto the PD 21.

Thus, the laser beam transmitting through the beam splitter 13 is incident on and enters the polarization beam splitter 14, which has different transmittances and reflectances according to the polarization direction of the laser beam. Note that the term “incidence plane” Will be used hereafter to mean a plane which is formed by the normal of a plane on which a laser beam emitted from the LD unit 10 is incident, and by the propagation direction of the laser beam. The polarization beam splitter 14 transmits linearly polarized light vibrating in a direction parallel to the incidence plane, and reflects linearly polarized light vibrating in a direction perpendicular to the incidence plane. Thus, among the laser beams emitted from the LD unit 10, a linearly polarized laser beam vibrating in a direction parallel to the incidence plane passes or transmits through the polarization beam splitter 14, and is irradiated onto the optical disc 2 via a quarter (¼) wavelength plate 15.

The quarter wavelength plate 15 converts linearly polarized light into circularly polarized light, and converts circularly polarized light into linearly polarized light. The laser light emitted from the LD unit 10 for irradiation onto the optical disc 2 is linearly polarized light, and thus the quarter wavelength plate converts the laser beam to circularly polarized light. The thus converted laser beam with circular polarization is condensed or collected by an objective lens 16 and irradiated onto the optical disc 2. The objective lens 16 is moved to adjust the position of the condensing point and the spot diameter of the condensed light, which is originally emitted from the LD unit 10 and then condensed and irradiated onto the optical disc 2.

A reflected laser beam reflected from the optical disc 2 enters the quarter wavelength plate 15 via the objective lens 16. The reflected laser beam is converted by the quarter wavelength plate 15 from the circularly polarized light back to linearly polarized light. The reflection at the optical disc 2 causes the circularly polarized light of the reflected laser beam to rotate in a direction opposite to that prior to the reflection. Accordingly, the linearly polarized light of the reflected laser beam converted by the quarter wavelength plate 15 rotates in a direction perpendicular to the incidence plane.

The reflected laser beam having been converted to the linearly polarized light enters the polarization beam splitter 14. Since the entering reflected laser beam vibrates in a direction perpendicular to the incidence plane, all the reflected laser beam is reflected by the polarization beam splitter 14, and enters a PD (photodetector) 19 via a condenser lens (collecting lens) 17 and a cylindrical lens 18. The condenser lens 17 is used to condense the reflected laser beam, and to irradiate the reflected laser beam having thus been condensed onto the PD 19. The cylindrical lens 18 is used to correct the astigmatism of the laser beam thus condensed and irradiated onto the optical disc 2.

The PD 19 receives and detects the reflected laser beam which is originally emitted from the LD unit 10 and reflected from the optical disc 2. The reflected laser beam contains recorded information (data) such as video and audio recorded on the optical disc 2. The PD 19 generates a light detection signal varying in current amplitude according to the power of the reflected laser beam which it receives. The current amplitude increases and decreases as the power of the reflected laser beam increases and decreases, respectively. The light detection signal is a signal obtained by photoelectrically converting the reflected laser beam containing the recorded information recorded on the optical disc 2, and thus similarly contains recorded information, which causes the current to vary according thereto. The light detection signal is output to e.g. an optical disc recording apparatus having the optical pickup apparatus 1 mounted therein in order to reproduce data recorded on the optical disc 2.

Among the laser beams emitted from the LD unit 10, the laser beam reflected by the beam splitter 13 enters the PD 21 via a condenser lens 20. The PD 21 generates a light detection signal varying in current amplitude according to the power of the reflected laser beam which it receives. The current amplitude increases and decreases as the power of the reflected laser beam increases and decreases, respectively. The light detection signal is output to the laser power control unit 3 in order to, control the power of a laser beam emitted from the LD unit 10. Based on the light detection signal from the PD 21, the laser power control unit 3 controls the power of a laser beam to be emitted from the LD unit 10. Based on a signal from the laser power control unit 3, the LD unit 10 emits a laser beam. This arrangement makes it possible to control the power of laser beams emitted from the LD unit 10 and irradiated onto the optical disc 2.

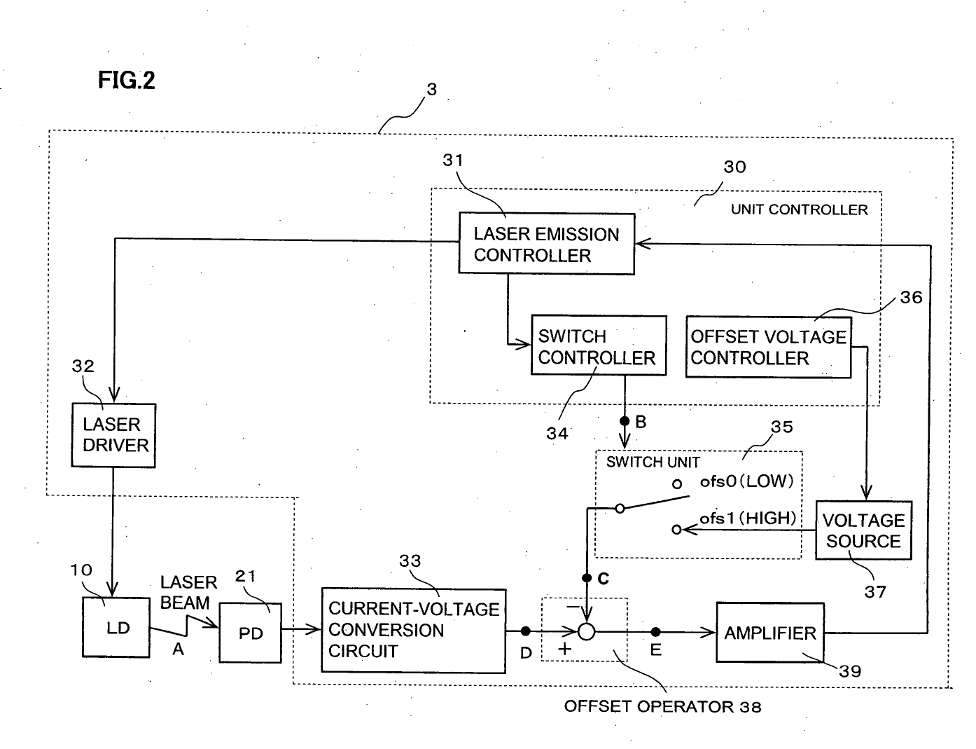

FIG. 2 is a schematic block diagram of the laser power control unit 3 of the optical pickup apparatus 1. The laser power control unit 3 comprises a unit controller 30 formed e.g. of a CPU (central processor unit) which comprises a laser emission controller 31, a switch controller 34 and an offset voltage controller 36. The LD unit 10 emits a laser beam (laser beam at point A in FIG. 2) based on a signal from the laser emission controller 31. The laser power control unit 3 further comprises a PD 21 which receives an emitted laser beam via a beam splitter 13 (refer to FIG. 1) to output a light detection signal in the form of a current signal based on the received laser beam. The form of the light detection signal is converted from the current signal to a voltage signal by a current-voltage conversion circuit 33, and is offset by a switch unit 35 when a laser beam is emitted to record data on the optical disc 2.

In the present specification, the term “offset” is used to mean that the voltage signal is adjusted in voltage, and more particularly reduced in voltage by a voltage drop, which is referred to as “offset voltage”. The light detection signal in the form of a voltage signal is applied to, and offset by, an offset operator 38 for reducing the voltage of the light detection signal by an offset voltage which is determined by an offset voltage controller 36. The thus offset light detection signal is amplified by an amplifier 39 (amplifier unit) and applied to the laser emission controller 31. Based on the amplified light detection signal, the laser emission controller 31 controls the power of the laser beam emitted from the LD unit 10.

More specifically, the laser emission controller 31 outputs a control signal to a laser driver 32 for controlling the wavelength, emission timing, power and so on of a laser beam to be emitted from the LD unit 10. The laser driver 32 has a laser drive circuit to emit a laser beam to the LD unit 10 based on the control signal from the laser emission controller 31. The infrared laser beam, red laser beam or blue laser beam emitted from the LD unit 10 enters the PD 21 via the beam splitter 13. The combination of the laser emission controller 31 and laser driver 32 thus operates to serve as a laser control unit.

The PD 21 receives and detects the laser beam from the LD unit 10, and outputs, to a current-voltage conversion circuit 33, a light detection signal in the form of a current signal which varies in amplitude according to the variation of the power of the detected laser beam. The current-voltage conversion circuit 33 is a circuit having a resistor, an operational amplifier and so on, and converts a current signal to a voltage signal. Thus, the current-voltage conversion circuit 33 outputs, to an amplifier 39, a light detection signal which varies in voltage according to the power of the laser beam. The combination of the PD 21 and current-voltage conversion circuit 33 thus operates to serve as a light detection unit.

The switch controller 34 controls the switch unit 35. Based on a signal from the laser emission controller 31, the switch controller 34 recognizes the timing of recording marks and timing of erasing originally recorded data (recording spaces) when recording or writing new data onto the optical disc 2. Based on these timings, the switch controller 34 outputs a control signal to the switch unit 35. It is to be noted that the switch controller 34 can also be designed to control the switch unit 35 based on a signal from another controller such as a controller to command the laser emission controller 31 to record or write data, rather than based on the signal from the laser emission controller 31.

The switch unit 35 consists, for example, of a switching circuit, and operates on the basis of a signal from the switch controller 34. The switch unit 35 performs a switching operation to output binary voltages as offset voltages when the optical pickup apparatus 1 records data on the optical disc 2. One of the offset voltages is ofs0 (ofs for offset) which is output from an ofs0 (LOW) in the switch unit 35 while the optical pickup apparatus 1 is used to record each space, and has a voltage [V] of, for example, 0 (zero). The other one of the offset voltages is ofs1 which is output from an ofs1 (HIGH) in the switch unit 35 while recording a mark, and has a voltage determined by an output from a voltage source 37 connected to the switch unit 35 (connected to the ofs1). For example, when the switch controller 34 outputs a mark/space identification (ID) signal (signal at point B in FIG. 2) which is a control signal consisting of binary values, that are HIGH indicating recording of a mark and LOW indicating recording of a space, then the switch unit 35 outputs the ofs1 voltage and ofs0 voltage when the control signal is HIGH and LOW, respectively, so as to generate an offset signal (signal at point C in FIG. 2).

The light detection signal (signal at point D in FIG. 2) output from the current-voltage conversion circuit 33 is offset by the offset operator 38 such that the offset operator 38 subtracts, from the light detection signal, voltages of the offset signal which correspond to the offset voltages. Thus, the offset operator 38 consists of a subtraction circuit for subtracting the voltages of the offset signal from the voltage of the light detection signal. Here, since the offset voltage ofs0 for recording spaces is 0 [V], the light detection signal is offset only when recording marks. The thus offset light detection signal is input to the amplifier as a front monitor signal (signal at point E in FIG. 2). The combination of the switch controller 34, switch unit 35 and offset operator 38 thus operates to serve as an offset unit. The offset voltage controller 36 controls the voltage source 37 to control the voltage value of the offset voltage ofs1 applied to the switch unit 35. The combination of the offset voltage controller 36 and voltage source 37 thus operates to serve as an offset control unit.

The amplifier 39 amplifies the front monitor signal, which is the light detection signal having been offset by the offset operator 38, and outputs the thus amplified light detection signal to the laser emission controller 31. The amplifier 39 consists, for example, of an amplifying circuit including e.g. an operational amplifier. Based on the amplified light detection signal, the laser emission controller 31 outputs a command signal to the laser driver 32 to control e.g. the power of the laser beam emitted from the LD unit 10. The laser driver 32 consists of a laser driving circuit, and commands the LD 10 to emit a laser beam based on the command signal from the laser emission controller 31. The combination of the laser emission controller 31 and laser driver 32 thus operates to serve as a light control unit.

As described above, the voltage of the light detection signal is offset, so that it is possible to amplify the light detection signal by the amplifier 39 within the dynamic range of the laser emission controller 31 which is provided at a stage after the offset. Thus, a small change in the voltage of a light detection signal, which is caused by a small change in the power of a laser beam, causes an amplified change in the voltage of the amplified light detection signal, thereby making it possible to control the laser beam power with high accuracy based on the amplified light detection signal.

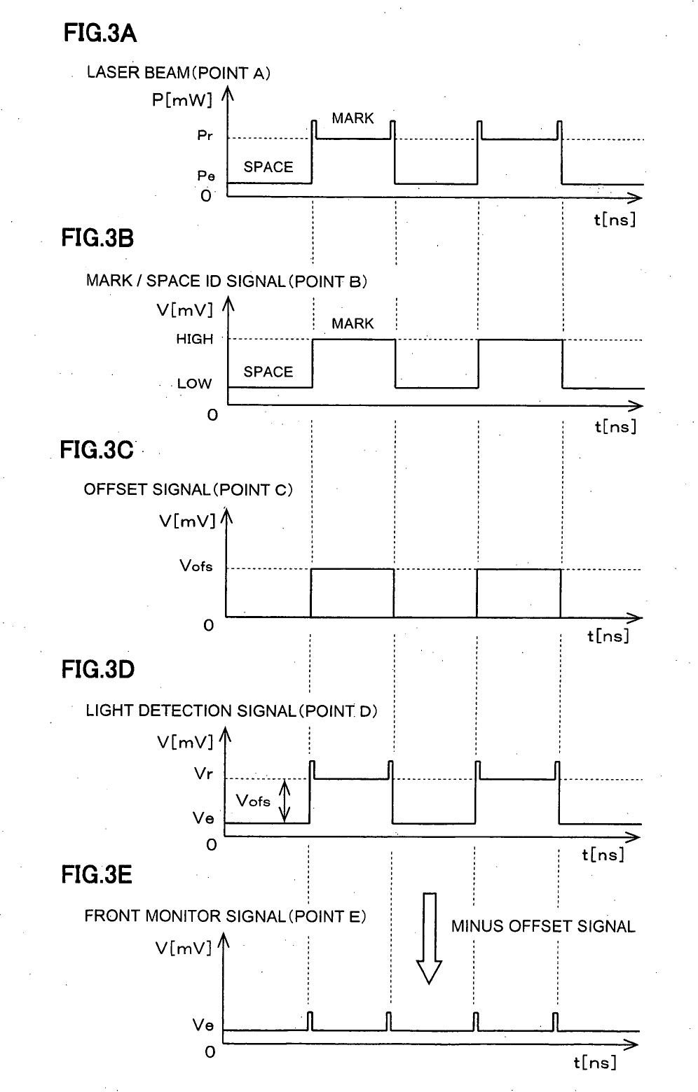

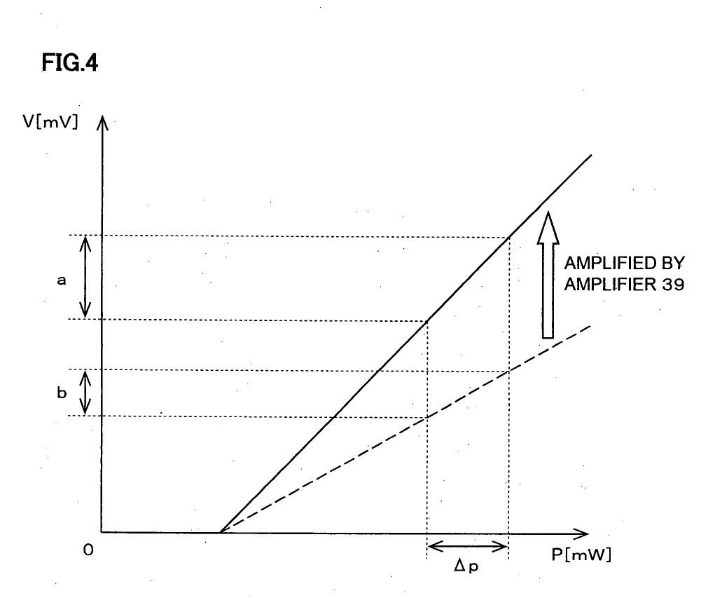

Hereinafter, the operation of the laser power control according to the present embodiment will be described in more detail with reference to FIGS. 3A to 3E and FIG. 4. First, FIGS. 3A to 3E are a set of graphs showing various signals in the laser power control unit 3 of FIG. 2 when recording data on an optical disc 2, in which FIG. 3A is a graph showing the power of a laser beam at point A, while FIG. 3B to FIG. 3E are graphs showing voltages of a mark/space ID (identification) signal at point B, an offset signal at point C, a light detection signal at point D, and a front monitor signal at point E in FIG. 2, respectively. These will be described in more detail below.

FIG. 3A is a graph showing a power waveform of an example of a laser beam (at point A in FIG. 2) which is emitted from the LD unit 10 when recording data on the optical disc 2. The vertical axis represents the power of the laser beam in mW (milliwatts), while the horizontal axis represents time in ns (nanoseconds). In FIG. 3A, P stands for power, Pr for recording power, and Pe for erasing power. When recording data on the optical disc 2, the LD 10 is driven by the laser driver 32 based on a signal from the laser emission controller 31 so as to emit a laser beam having a recording power for forming or recording marks (record marks) on the optical disc 2 to record new information on the optical disc 2, and also so as to emit a laser beam having an erasing power for forming or recording spaces on the optical disc 2 to erase recorded marks on the optical disc 2. The recording power is higher than the erasing power so as to record marks. As shown in FIG. 3A, errors occur in the power of the laser beam when the power rises from the erasing power to the recording power, and when the power falls from the recording power to the erasing power. Note that the recording time of each of the marks and spaces is, for example, 2T to 11T where T is a channel clock period.

FIG. 3B is a graph showing a waveform of a mark/space identification signal (at point B in FIG. 2) which is input to the switch unit 35 from the switch controller 34. The vertical axis represents the voltage (V) of the signal in mV (millivolts), while the horizontal axis represents time in ns. Based e.g. on a signal from the laser emission controller 31 to control the LD unit 10, the switch controller 34 recognizes the timing of recording marks and the timing of recording spaces. Based on these timings, the switch controller 34 outputs a mark/space identification signal to the switch unit 35. As shown in FIG. 3B, the voltage of the mark/space identification signal during the mark recording is a specific voltage such as HIGH, while that during the space recording is a specific voltage such as LOW which is lower than HIGH. The voltage value of these HIGH and LOW are determined e.g. by the circuit design of the switch unit 35.

FIG. 3C is a graph showing a waveform of an offset signal (at point C in FIG. 2) which is input to the offset operator 38 from the switch unit 35. The vertical axis represents the voltage (V) of the signal in mV, while the horizontal axis represents time in ns. When a mark/space identification signal is input to the switch unit 35, the switch unit 35 outputs the voltage of the ofs1 if the signal is HIGH (for recording a mark), and outputs the voltage of the ofs0 if the signal is LOW (for recording a space) so as to generate an offset signal. The voltage of the ofs0 is 0 [V] here, while the voltage (i.e. offset voltage) of the ofs1 is determined by the offset voltage controller 36. The offset voltage controller 36 sets an offset voltage Vofs (ofs1=Vofs) which is a difference voltage between the voltage of a light detection signal corresponding to the recording power of the laser beam and that corresponding to the erasing power of the laser beam. The offset voltage Vofs is determined by the circuit specification, so that the offset voltage controller 36 stores the offset voltage Vofs therein (in a not shown memory).

FIG. 3D is a graph showing a waveform of a light detection signal (at point D in FIG. 2) which is input to the offset operator 38 from the current-voltage conversion circuit 33. The vertical axis represents the voltage (V) of the signal in mV, while the horizontal axis represents time in ns. FIG. 3D shows a voltage Vr (recording voltage) of a light detection signal to be output from the current-voltage conversion circuit 33 based on a current corresponding to the recording power output from the PD 21 while the laser beam received thereby has the recording power. FIG. 3D also shows a voltage Ve (erasing voltage) of the light detection signal to be output from the current-voltage conversion circuit 33 based on a current corresponding to the erasing power output from the PD 21 while the laser beam received thereby has the erasing power. The difference between the voltage Vr and the voltage Ve coincides in principle with the offset voltage Vofs. As shown in FIG. 3D, similarly as in FIG. 3A, errors occur in the light detection signal when the power of the laser beam rises from the erasing power to the recording power, and when it falls from the recording power to the erasing power.

FIG. 3E is a graph showing a waveform of a front monitor signal (at point E in FIG. 2) which is input to the amplifier 39 from the offset operator 38. The vertical axis represents the voltage (V) of the signal in mV, while the horizontal axis represents time in ns. The offset operator 38 subtracts the voltage of the offset signal from the voltage of the light detection signal, so that the front monitor signal is a signal which corresponds to the light detection signal, and which is obtained by such subtraction (namely, the light detection signal minus the offset signal). The offset signal has a voltage of 0 [mV] when the optical pickup apparatus 1 is used to record each space, while it has a voltage of Vofs [mV] when recording each mark, so that the light detection signal is offset by the subtraction of the offset voltage Vofs from the voltage of the light detection signal while a laser beam to record each mark is emitted onto the optical disc 2.

Thus, the voltage of the front monitor signal during the mark recording has a value substantially the same as the voltage Ve during the space recording, whereby the voltage amplitude of the front monitor signal is reduced. Even after the offset, errors with small voltage values as caused by e.g. power control errors of the laser beam still remain in the front monitor signal such as shown in FIG. 3E. Accordingly, when the amplifier 39 amplifies the front monitor signal, the amplifier 39 amplifies the errors as well, so that the output signal of the amplifier 39 consequently contains amplified errors.

In this way, the optical pickup apparatus 1 according to the present embodiment reduces, by an offset, the voltage of a light detection signal corresponding to a recording power to a voltage corresponding to an erasing power, thereby reducing the voltage amplitude of the light detection signal. This makes it possible for the amplifier 39 to amplify the light detection signal within a range in which the voltage of a light detection signal input to the laser emission controller 31 subsequent to the amplification does not exceed the dynamic range of the laser emission controller 31. In addition, the optical pickup apparatus 1 makes it possible to amplify the light detection signal more than without the offset. The amplified light detection signal is used to realize an optical pickup apparatus 1 capable of controlling the power of a laser beam with high accuracy even when emitting a laser beam having a high power. This will be described in detail below.

As described above, the light detection signal is amplified, so that a change (rate of change) in the voltage of the light detection signal with a change in the power of the laser beam increases. This will be described with reference to FIG. 4, which is a graph showing how characteristics of the light detection signal voltage versus laser beam power are changed by the amplification of the light detection signal. The horizontal axis of the graph represents the power (P) in mW of a laser beam emitted from the LD unit 10 and entering the PD 21. On the other hand, the vertical axis represents the voltage (V) in mV of a light detection signal input to the laser emission controller 31. The characteristics of the light detection signal voltage versus laser beam power can be represented by a straight line on the graph. In the case where a light detection signal is amplified by the amplifier 39, the gradient of the straight line increases. This increases a change in the light detection signal voltage with a change in the laser beam power.

For example, assume the laser beam power changes by Δp [mW] (small change). If the light detection signal is not amplified, the voltage of the light detection signal changes by b [mV] with the change in the laser beam power by Δp [mW]. On the other hand, if the light detection signal is amplified, the light detection signal changes by a [mV] with the change in the laser beam power by Δp [mW]. Since a>b, the small change in the laser beam power causes a greater change in the light detection signal voltage than without the amplification. The amplified light detection signal is input to the laser emission controller 31, so that based on a change or changes of the light detection signal having thus been amplified, the laser emission controller 31 can accurately detect a small change or changes in the laser beam power which are caused e.g. by control errors. Thus, the laser emission controller 31 makes it possible to control, with high accuracy, the power of a laser beam emitted from the LD unit 10.

Besides, the laser power control unit 3 offsets and amplifies a light detection signal, regardless of the value of a recording power, i.e. the value of the light detection signal voltage when recording each mark. Even when a laser beam having a high recording power is allowed to enter the PD 21, a light detection signal voltage then is offset by a difference, voltage between a light detection signal voltage based on the high recording power and that based on an erasing power. Thus, even if the recording power of a laser beam is high, the voltage of the light detection signal having been offset is substantially the same as the voltage of the light detection signal based on the erasing power. This makes it possible to amplify the thus offset light detection signal to control the laser beam power with high accuracy.

An example of a case where a laser beam having a high recording power is required is recording data at a high speed. This is because in order to record data at a high speed, it is required to record data on e.g. a rotating optical disc in a short time. In other words, it is required to heat e.g. the optical disc in a short time in order to record a mark and a space. Another example requiring a high power laser beam is recording data on a multi-layer optical disc having multiple data recording layers. This is because it is required to use a laser beam which passes through a first data recording layer at a shallowest depth, and which arrives at a further data recording layer at a depth deeper than the first data recording layer, so as to record a mark and a space on the further data recording layer.

It is to be noted that the present invention is not limited to the above embodiments, and various modifications are possible within the spirit and scope of the present invention. For example, the power of a laser beam to be emitted from the LD 10 is not limited to one value. In order to adapt to an optical disc having multiple data recording layers, the power of the laser beam can have multiple values to record data on the multiple data recording layers. Further, although the above embodiments assume that the LD unit 10 has three LDs (infrared emitting, red emitting and blue emitting LDs), the number of LDs can be two or even one of them depending on the purpose. Furthermore, the optical recording media to be applied to the optical pickup apparatus 1 are not limited to CD-RW, DVD−RW, DVD+RW, HD DVD and Blu-ray Disc, which are capable of rewriting data. The optical recording media can be CD-R (CD Recordable), DVD−R (DVD Recordable), DVD+R (DVD Recordable different from DVD−R), HD DVD and Blu-ray Disc, which are capable of recording data or write-once.

The light detection unit is also not limited to the combination of the PD 21 and current-voltage conversion circuit 33, and can be a photodetector element or a photodetector device which outputs a voltage signal according to a laser beam. Further, the arrangement position of various optical elements in the optical pickup apparatus 1 such as the collimating lens 11 and condenser lens 17 is not limited to that shown in FIG. 1, and can be modified within a range to achieve an effect similar to the optical pickup apparatus 1. It is also possible to add, to the optical pickup apparatus 1, a further collimating lens, a further condenser lens as well as a diffraction grating. In addition, the offset voltage Vofs is not limited to simply the difference between the voltage of a light detection signal corresponding to a recording power and that corresponding to an erasing power. Considering a -power error of a laser beam caused by a control error, the offset voltage Vofs can be a voltage of the above-described difference plus or minus a certain voltage corresponding to an error voltage of the light detection signal based on the control error.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. An optical pickup apparatus comprising:
a light emitting unit for emitting a laser beam to an optical recording medium;
a light control unit for controlling power of the laser beam emitted from the light emitting unit;
a light detection unit for receiving and detecting the laser beam emitted from the light emitting unit, and outputting a light detection signal which varies in voltage according to the power of the detected laser beam;
an offset unit for subtracting an offset voltage from the voltage of the output light detection signal so as to offset the light detection signal; and
an amplifier unit for amplifying the offset light detection signal, and outputting the amplified light detection signal to the light control unit,
wherein based on the amplified light detection signal, the light control unit controls the power of the laser beam emitted from the light emitting unit.

2. The optical pickup apparatus according to claim 1,
which further comprises an offset control unit for controlling the offset voltage, wherein:
based on a signal from the light control unit, the light emitting unit emits a laser beam having a recording power to record a mark on the optical recording medium, and also emits a laser beam having an erasing power to erase the mark recorded on the optical recording medium, thereby recording information on the optical recording medium;
the offset control unit sets an offset voltage which is a difference voltage between the voltage of a light detection signal corresponding to the recording power of the laser beam and that corresponding to the erasing power of the laser beam; and
the offset unit subtracts the offset voltage from the voltage of the light detection signal while the laser beam is emitted to the optical recording medium to record the mark thereon.
